(19) United States
(12) Patent Application Publication
(10) Pub. No.: US 2007/0108902 A1
(43) Pub. Date: May 17, 2007

(54) Plasma display panel

(76) Inventor: Sang-Hoon Yim, Yongin-si (KR)

Correspondence Address: Robert E. Bushnell, Suite 300, 1522 K Street, N.W., Washington, DC, 20005, US

(21) Appl. No.: 11/516,664

(22) Filed: Sep. 7, 2006

(30) Foreign Application Priority Data
Sep. 7, 2005 (KR) 10-2005-0083107

(51) Int. Cl. H01J 17/49

(52) U.S. Cl. 313/582

(57) ABSTRACT

A plasma display panel may employ an effective picture area including entire display areas exclusively, so that the color balance is obtained even in edge portions of the effective picture area. In addition, if the non-display area is provided within the effective picture area, an external light absorber is provided in the non-display area, so that the reflection brightness of the external light incident into the non-display area is reduced, thereby improving the bright room contrast of the plasma display panel.

### CLAIMS OF PRIORITY

This application makes reference to, incorporates the same herein, and claims all benefits accruing under 35 U.S.C. §119 from an application for PLASMA DISPLAY PANEL earlier filed in the Korean Intellectual Property Office on 7 Sep. 2005 and there duly assigned Ser. No. 10-2005-0083107.

### BACKGROUND OF THE INVENTION

1. Field of the invention

The present invention relates to a plasma display panel. More particularly, the present invention relates to a delta type plasma display panel capable of improving a bright room contrast by balancing colors representing a picture image.

2. Description of the Prior Art

As generally known in the art, a plasma display panel (PDP) refers to a display device for realizing an image using a visible light ray, which is generated when a fluorescent member is excited by means of a vacuum ultraviolet ray radiated from plasma derived from a gas discharge. Such a PDP makes it possible to fabricate a large screen of above 60 inches with a thickness less than 10 cm. In addition, since the PDP is a self-emissive display device similar to a CRT (cathode ray tube), the PDP has superior color reproducing characteristics while preventing the image from being distorted regardless of the viewing angle. In addition, the fabrication process for the PDP is easier than that of a liquid crystal display (LCD), so the PDP can be produced at a low cost. Due to these advantages s of the PDP, the PDP has been extensively used as a flat display device in next-generation industrial fields and as a TV display device at home.

Such a PDP generally includes a front substrate having a plurality of display electrodes and a rear substrate having a plurality of address electrodes crossing the display electrodes. Both display electrodes and address electrodes may be referred to as discharge electrodes. In addition, a plurality of barrier ribs are provided between the front substrate and the rear substrate in order to define a plurality of discharge areas. The barrier ribs are classified into stripe type barrier ribs, matrix type barrier ribs and delta type barrier ribs.

In the case of a PDP having the delta type barrier ribs, a pixel is defined by three discharge cells that are adjacent to each other. In addition, each discharge cell is constructed with a red (R) fluorescent layer, a green (G) fluorescent layer or a blue (B) fluorescent layer. In general, three address electrodes are allocated to one pixel in the delta type PDP. In order to produce a high definition PDP, a barrier rib structure capable of reducing capacitance between address electrodes, and an electrode structure capable of restricting an increase of the discharge voltage are necessary. Therefore, a rotary delta type barrier rib structure has been suggested. According to the rotary delta type PDP, two address electrodes may be allocated to one pixel. In other words, for the three adjacent discharge cells that define one pixel, one address electrode is commonly allocated to two discharge cells selected from the three discharge cells and a different address electrode is allocated to the remaining discharge cell.

Hereinafter, the operation of a PDP having the above structure will be briefly described. First, a discharge cell is selected by applying an electric signal to a Y display electrode of the display electrodes and an address electrode. Then, an electric signal is applied to an X electrode of the display electrodes followed by the Y electrode, so the surface-discharge is generated from the surface of the front substrate, thereby generating ultraviolet rays. The ultraviolet rays excite the fluorescent layer of the selected discharge cell, so that visible light rays are radiated from the fluorescent layer, thereby realizing still images or dynamic images.

The PDP operating in this manner exhibits a contrast ratio which can be classified into a bright room contrast and a dark room contrast. The bright room contrast refers to the contrast of an image displayed by a PDP, when a light source of 150 lux or greater exists at the exterior of the PDP and the PDP receives the effect of the external light generated from the light source. The dark room contrast refers to the contrast an image displayed by a PDP when a light source of 21 lux or less exists at the exterior of the PDP and the PDP receives no substantial effect from the external light generated from the light source.

In general, viewers watch the PDP in a bright room, instead of a dark room, so the bright room contrast must be improved in order to enhance the image quality of the PDP. Therefore, it is necessary to reduce the reflection brightness of the PDP. Accordingly, the internal structure of the PDP must be modified to reduce the reflection brightness of the PDP such that the bright room contrast of the screen can be improved.

The general delta type PDP or the rotary delta type PDP, however, has the following problems related to the effective picture area of the PDP.

The effective picture area refers to an area of a front panel with the exception of a part covered by a bezel of a front case. In other words, the effective picture area is that part of a screen area that is revealed to outside. Contemporary effective picture areas have rectangular shape.

A PDP may include display areas, which include the discharge cells exclusively and which are capable of displaying images using discharge electrodes when a discharge voltage is applied, and non-display areas, which are non-emissive areas aligned at outer portions of the display areas.

In a delta type PDP having a rectangular effective picture area, if the rectangular effective picture area is established to cover the entire display areas, empty spaces (i.e., non-display areas) may be undesirably formed, because the shape of the delta type barrier ribs will inevitably result in a mismatch between the effective picture area and the display areas.

The empty spaces are typically coated with a dielectric layer or a fluorescent layer. The dielectric layer and the fluorescent layer are white in color, so they exhibit superior reflection brightness in response to the incidence of external light onto the empty spaces. If the empty spaces have superior reflection brightness, the bright room contrast of the PDP may be degraded, thereby lowering the image quality of the PDP.

In order to solve the above problem, the pixels defined by the hexagonal discharge cells are shifted with respect to the effective picture area, such that the spaces which were originally the empty spaces, i.e., the spaces in the effective picture area that were originally not covered by the pixels, will be covered by the pixels. In this case, however, a part of the pixels, that was originally belonging to the display areas, deviates from the effective picture area. Such a deviation of the pixels may be incurred in the general delta type PDP.

As mentioned above, according to the delta type PDP, one pixel is defined by three adjacent discharge cells and each discharge cell radiates visible rays of red, green or blue colors. In addition, the delta type PDP generates various colors by mixing the visible rays. If a part of the pixel deviates from the effective picture area, however, a part of the red, green or blue color may not be viewed by the viewers, and therefore an input color signal may not match with an output color signal. For this reason, a color unbalance may occur at the edge portions of the effective picture area, so that it is difficult to exhibit the desired color, which is intended to be seen by the optical facilities of the viewers.

### SUMMARY OF THE INVENTION

It is therefore an object of the present invention to provide an improved delta type plasma display panel.

It is another object of the present invention to provide an improved delta type plasma display panel in order to solve one or more of the above-mentioned problems occurring in the prior art.

It is still another object of the claimed invention is to provide a delta type plasma display panel capable of improving a bright room contrast by balancing colors representing a picture image.

In order to accomplish the above objects, according to one aspect of the present invention, a plasma display panel may be constructed with front and rear substrates aligned opposite to each other, a plurality of barrier ribs provided between the front and rear substrates in order to define a plurality of discharge areas such that a pixel is formed by three adjacent discharge cells radiating visible rays having different colors and being aligned in a triangular pattern, a plurality of electrodes aligned on at least one of the front substrate, the rear substrate, and the barrier ribs corresponding to the discharge cells, and a fluorescent layer formed in the discharge cells. The plasma display panel includes display areas as a set of pixels, which are emissive areas, and non-display areas which are non-emissive areas aligned outside of the display areas, and an external light absorber is provided in the non-display areas.

According to the exemplary embodiment of the principles of the present invention, the plasma display panel has a rectangular effective picture area which includes the entire display areas absorber is provided in the non-display areas located in the effective picture area.

At this time, an external light absorber is provided in either a front surface or a rear surface of the front substrate corresponding to the non-display areas. The external light absorber area includes a recess having a depth, in which the recess is formed in a front surface of the front substrate corresponding to the non-display areas and is filled with light shielding materials. The external light absorber may be disposed on the barrier ribs forming the discharge cells, the fluorescent layer or a dielectric layer corresponding to the non-display areas.

In addition, a dummy wall is formed in the non-display areas located in the effective picture area, in which the dummy wall extends from a barrier rib forming an outermost portion of the display areas and the external light absorber is provided on the dummy wall.

The external light absorber is made from a material having a surface color of black.

According to another aspect of the present invention, a plasma display panel is constructed with front and rear substrates aligned opposite to each other, barrier ribs provided between the front and rear substrates in order to define a plurality of discharge areas such that a pixel is formed by three adjacent discharge cells radiating visible rays having different colors and being aligned in a triangular pattern, a plurality of kinds of electrodes aligned on at least one of the front substrate, the rear substrate, and the barrier ribs corresponding to the discharge cells, and a fluorescent layer formed in the discharge cells, wherein the plasma display panel includes display areas, which are emissive areas, and non-display areas which are non-emissive areas aligned outside of the display areas, and an effective picture area is established by covering the entire display areas, exclusively.

According to the exemplary embodiment of the principles of the present invention, a front case surrounding the plasma display panel is provided such that an entire non-display area is covered with the bezel of the front case.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a schematic view illustrating empty spaces formed in a contemporary delta type PDP having a rectangular effective picture area;

FIG.2 is a schematic view illustrating a contemporary delta type PDP in which pixels have been shifted in order to cover empty spaces;

FIG. 3 is a partially enlarged perspective view illustrating a PDP constructed as one embodiment of the principles of the present invention;

FIG. 4 is a front view of the PDP shown in FIG. 3;

FIG. 5 is a partially enlarged perspective view illustrating a PDP constructed as another embodiment of the principles of the present invention; and

FIG. 6 is a front view of a PDP constructed as still another embodiment of the principles of the present invention.

### DETAILED DESCRIPTION OF THE PREFERRED EMBODIMENTS

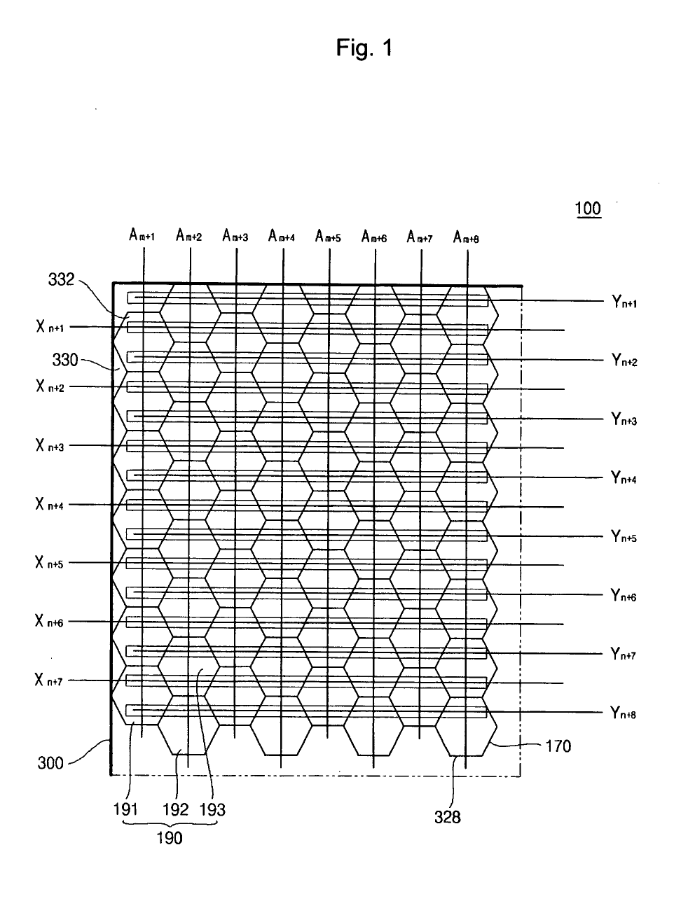

FIG. 1 is a front view of a rotary delta type plasma display panel (PDP) 100 having a contemporary rectangular effective picture area 300. Herein, effective picture area 300 refers to an area of a front panel with the exception of a part covered with a front case. That is, effective picture area 300 is a screen area that displays images viewed by the optical facilities of the viewers.

A PDP includes display areas 332 capable of displaying images using discharge electrodes, to which a discharge voltage is applied, and non-display areas 330, which are non-emissive areas aligned at outer portions of display areas 332.

As shown in FIG. 1, in delta type PDP 100 having rectangular effective picture area 300, if rectangular effective picture area 300 is established to cover entire display areas, empty spaces 330 (i.e., non-display areas) may be undesirably formed because the shape of delta type barrier ribs 170 will inevitably result in a mismatch between effective picture area 330 and display areas 332.

Although FIG. 1 shows empty spaces 330 (i.e., non-display areas) formed in rotary delta type PDP 100 having hexagonal discharge cells 191, 192 and 193, in which each hexagonal discharge cell is formed in such a way that upper and lower end portions 328 of the hexagonal discharge cell are horizontal lines when viewed from the front of the hexagonal discharge cell, empty spaces 330 can also be formed in the general delta type PDP having hexagonal cells 191, 192 and 193, in which each hexagonal cell is formed in such a way that left and right end portions of the hexagonal cell are vertical lines when viewed from the front of the discharge cell, because in this arrangement, effective picture area 300 does not match with display areas 332 either.

Such empty spaces 330 are typically coated with a dielectric layer or a fluorescent layer. The dielectric layer and the fluorescent layer are white in color, so they exhibit superior reflection brightness in response to the incidence of external light onto non-display areas 330 (i.e., empty spaces). If non-display areas 330 have superior reflection brightness, the bright room contrast of the PDP may be degraded, thereby lowering the image quality of the PDP.

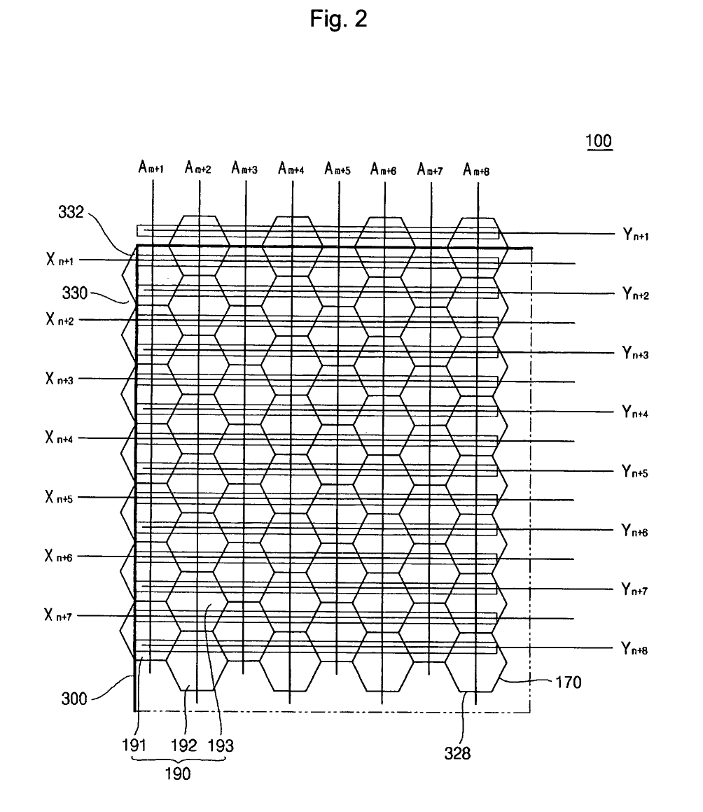

In order to solve the above problem, pixels 190 defined by three hexagonal discharge cells 191, 192 and 193 have been shifted with respect to effective picture area 300, as shown in FIG. 2, such that empty spaces 330 in effective picture area 300 can be covered by pixels 190.

Referring to FIG. 2, pixels 190 defined by three hexagonal discharge cells 191, 192 and 193 have been shifted with respect to effective picture area 300 such that empty spaces 330 in effective picture area 300 that were originally not covered by pixels 190 can be covered by pixels 190. In this case, however, a part of pixels 190 that was originally belonging to display areas 332 deviates from effective picture area 300. Although FIG. 2 only shows the rotary delta type PDP, such a deviation of the pixel may be incurred in the general delta type PDP.

As mentioned above, according to the delta type PDP, one pixel is defined by three adjacent discharge cells and each discharge cell radiates visible rays of red, green or blue colors. In addition, the delta type PDP generates various colors by mixing the visible rays. If a part of the pixel deviates from effective picture area 300, however, an input color signal may not match with an output color signal. For this reason, a color unbalance may occur at the edge portions of effective picture area 300, so that it is difficult to exhibit the desired color, which is intended to be seen by the viewers.

Hereinafter, embodiments of a plasma display panel (PDP) according to the present invention will be described with reference to the accompanying drawings.

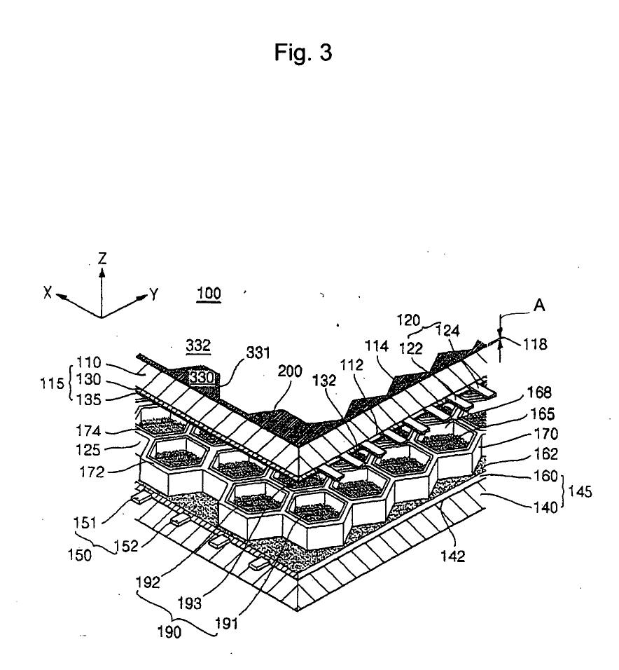

FIG. 3 is a partially enlarged perspective view illustrating a PDP constructed as one embodiment of the principles of the present invention.

Referring to FIG. 3, PDP 100 according to the principles of the present invention is constructed with a front substrate 110, a rear substrate 140 opposite to front substrate 110, barrier ribs 170 defining a space 125 between front and rear substrates 110 and 140 such that three discharge cells 191, 192 and 193 radiating visible rays having different colors are aligned in space 125 in a triangular pattern to form one pixel 190, a plurality of discharge electrodes including display electrodes 120 and address electrons 150 aligned on at least one of front substrate 110, rear substrate 140 and barrier ribs 170 corresponding to discharge cells 191, 192 and 193, a fluorescent layer 165 formed in discharge cells 191, 192 and 193, and an external light absorber 200 formed in a non-display areas 330. Discharge cells 191, 192 and 193 are filled with discharge gas for generating vacuum ultraviolet rays through plasma discharge.

In the following description, the direction which is perpendicular to and directed toward front substrate 110 (that is, the +Z direction in FIG. 3) is referred to as an upper direction, and the direction which is perpendicular to and directed toward to rear substrate 140 (that is, the −Z direction in FIG. 3) is referred to as a lower direction.

A front panel 115 is constructed with a front substrate 110, display electrodes 120, an upper dielectric layer 130 and a protective layer 135. Front substrate 110 is made of a transparent material, such as soda glass. In addition, Y display electrodes 122 and X display electrodes 124 are aligned on rear surface 112 of front substrate 110 and they are parallel to each other. Y and X display electrodes 122 and 124 are aligned in the Y direction of the substrate sequentially and seriatim. A pair of Y and X display electrodes 122 and 124 are allocated to each discharge cell. Y and X display electrodes 122 and 124 are covered with an upper dielectric layer 130, which is protected by a protective layer 135.

A rear panel 145 is constructed with a rear substrate 140, address electrodes 150 and a lower dielectric layer 160. Rear substrate 140 is made of a transparent material, such as soda glass and forms PDP 100 together with front substrate 110. Address electrodes 150 are formed at a front surface 162 of rear substrate 140 and aligned in a direction which is perpendicular to Y and X display electrodes 122 and 124, i.e., the Y direction in FIG. 3, and a lower dielectric layer 160 covers address electrodes 150. Barrier ribs 170 are provided on lower dielectric layer 160. A fluorescent layer 165 is formed on dielectric layer 160 and on parts of sidewalls 168 of barrier ribs 170.

As shown in FIG. 3, barrier ribs 170 can be formed on an entire surface of lower dielectric layer 160 with a thickness or in a position separated from rear panel 145. Barrier ribs 170 may form discharge cells having various shapes, such as a triangular shape, a rectangular shape, a lozenge shape, a pentagonal shape or a hexagonal shape. Although FIG. 3 shows barrier ribs 170 forming hexagonal shaped discharge cells 191, 192 and 193, the present invention is not limited to this shape. That is, the present invention is applicable for various delta type barrier ribs 170 forming discharge cells in various shapes. Barrier ribs 170 forms a space between front and rear panels 115 and 145 while defining discharge cells 191, 192 and 193.

In delta type barrier ribs 170, three discharge cells 191, 192 and 193 radiating visible rays having different colors are adjacent to each other in a triangular pattern, thereby forming one pixel 190. Herein, two address electrodes 150 are allocated to one pixel 190 defined by delta type barrier ribs 170. That is, one address electrode (e.g. address electrode 151) is commonly allocated to two discharge cells (e.g. discharge cells 192 and 193) selected from three discharge cells 191, 192, and 193 and a different address electrode (e.g. address electrode 152) is allocated to the remaining discharge cell (e.g. discharge cell 191).

Barrier ribs 170 can be fabricated through a screen-printing, a sandblasting, a lifting-off, or an etching scheme. The present invention, however, does not limit the fabrication processes for fabricating barrier ribs 170. In addition, barrier ribs 170 are made from glass including an element selected from the group of Pb, B, Si, Al and O. Preferably, barrier ribs 170 are made from a dielectric material including a filler, such as ZrO₂, TiO₂, or Al₂O₃, and a pigment, such as Cr, Cu, Co or Fe. The present invention, however, does not limit the materials for making barrier ribs 170 and barrier ribs 170 can be made from various dielectric materials. Barrier ribs 170 are white in color, so they produce superior reflection brightness in response to the incidence of external light onto barrier ribs 170. If barrier ribs 170 have superior reflection brightness, however, the bright room contrast of PDP 100 may be degraded, thereby lowering the image quality of PDP 100. For this reason, a black stripe layer 174 is formed on an front surface 172 of barrier ribs 170 or a part of front panel 115 corresponding to front surface 172 of barrier ribs 170 in order to improve the bright room contrast.

Upper dielectric layer 130 is constructed with display electrodes 120 and covers the entire rear surface 112 of front substrate 110. Upper dielectric layer 130 can be formed by uniformly screen-printing paste, which mainly includes glass powder having a low melting point, onto the entire rear surface 112 of front substrate 110. As is generally known in the art, upper dielectric layer 130 is transparent and serves as a capacitor during the discharge operation. In addition, upper dielectric layer 130 restricts the current and has a memory function. A protective layer 135 may be constructed on upper surface 132 of rear dielectric layer 130 in order to discharge a greater amount of secondary electrons during the discharge operation while reinforcing endurance of upper dielectric layer 130. Protective layer 135 can be formed through an electron beam process or a sputtering process using MgO or equivalent material. The present invention, however, does not limit the materials and fabrication processes for protective layer 135.

Lower dielectric layer 160 is constructed with address electrodes 150 and covers the entire front surface 142 of rear substrate 140. Lower dielectric layer 160 may be made from a material similar to the material forming upper dielectric layer 130.

Address electrodes 150 are aligned on front surface 142 of rear substrate 140, parallel to each other and spaced apart from each other. Address electrodes 150 substantially cross display electrodes 120. Each address electrode 150 extends in the Y direction (see, FIG. 3) while passing through discharge cells 191, 192 and 193 radiating visible rays with different colors. Address electrode 150 is fabricated by the sputtering, screen-printing, or photolithograph technique using Ag paste or equivalent material. The present invention, however, does not limit the materials and fabrication processes for the address electrode 150.

Display electrodes 120 are aligned on rear surface 112 of front substrate 110, parallel to each other and spaced apart from each other. Each display electrode 120 includes a pair of Y and X display electrodes 122 and 124. Preferably, display electrodes 120 are made from one selected from the group of indium tin oxide (ITO) (an oxide layer of In), SnO₂ (an oxide layer of Sn), and equivalent materials having superior light transmittance characteristics in order to improve the aperture ratio of front substrate 110. The present invention, however, does not limit the materials from which display electrodes 120 are made. In addition, display electrodes 120 are mainly fabricated by a sputtering process. The present invention, however, does not limit the fabrication processes for display electrodes 120. Meanwhile, a low-resistance bus electrode (not shown) can be provided on the surface of the display electrode 120 in order to restrict the voltage drop. Such a low-resistance bus electrode may be made from one selected from the group of Cr—Cu—Cr, Ag and equivalent materials. The present invention, however, does not limit the materials for the low-resistance bus electrode.

In the meantime, although it is not illustrated in figures, display electrodes 120 are aligned along barrier ribs 170 in the X direction (see, FIG. 3) while substantially crossing address electrodes 150. Therefore, three adjacent discharge cells 191, 192 and 193 coated with fluorescent layers 165 having different colors are aligned on the basis of Y and X display electrodes 122 and 124. The reason for aligning display electrodes 120 on barrier ribs 170 or in barrier ribs 170 instead of in the areas where barrier ribs 170 are not substantially presented, is to solve a problem derived from a narrow discharge space in the high definition PDP, because when display electrodes 120 are aligned on or in barrier ribs 170, display electrodes 120 do not occupy too much discharge spaces. Thus, a pair of display electrodes 120 are allocated to each pixel 190 defined by the barrier ribs 170.

Fluorescent layer 165 has components capable of generating visible light rays upon receiving ultraviolet rays. The red fluorescent layer formed in the discharge cell radiating a visible ray having a red color is made from fluorescent materials, such as Y(V,P)O₄:Eu. The green fluorescent layer formed in the discharge cell radiating a visible ray having a green color is made from fluorescent materials, such as Zn₂SiO₄:Mn. In addition, the blue fluorescent layer formed in the discharge cell radiating a visible ray having a blue color is made from fluorescent materials, such as BAM:Eu. Accordingly, fluorescent layer 165 is divided into red, green and blue fluorescent layers formed in adjacent discharge cells 191, 192 and 193, respectively. In addition, adjacent discharge cells 191, 192 and 193 formed with the red, green and blue fluorescent layers 165 are combined with each other, thereby forming a unit pixel 190 in order to realize a color image.

In the meantime, discharge gas, such as Ne—Xe or He—Xe, is injected into a discharge cell defined by front and rear panels 115 and 145 and barrier ribs 170.

Two address electrodes 150 are allocated to one pixel 190 defined by barrier ribs 170. One address electrode 150 may be commonly allocated to the red and green fluorescent layers 165 and the other address electrode 150 may be allocated to the blue fluorescent layer 165. It is possible, however, to commonly allocate one address electrode 150 to the green and blue fluorescent layers 165 while allocating the other address electrode 150 to the red fluorescence layer 165. In addition, it is also possible to commonly allocate one address electrode 150 to the blue and red fluorescent layers 165 while allocating the other address electrode 150 to the green fluorescence layer 165.

Discharge cells 191, 192 and 193 are defined by lower dielectric layer 160 formed on the front surface 142 of rear substrate 140, barrier ribs 170 and upper dielectric layer 130. Discharge gas (e.g. mixing gas made from Xe and Ne) is filled into discharge cells 191, 192 and 193 in order to generate the plasma discharge. In addition, as mentioned above, fluorescent layers 165 radiating visible rays of different colors upon receiving the ultraviolet rays generated by the plasma discharge are formed at corresponding areas of discharge cells 191, 192 and 193, respectively. The width or length of discharge cells 191, 192 and 193 may vary depending on the light emitting efficiency of fluorescent layers 165.

In addition, PDP 100 includes display areas 332 and non-display areas 330. An external light absorber 200 is formed in non-display areas 330. Referring to FIG. 3, external light absorber 200 is formed in non-display areas 330 provided at a front surface 114 of front substrate 110 (that is, a front surface of front substrate 110 when the PDP is uprightly installed).

Hereinafter, detail description will be made with respect to external light absorber 200.

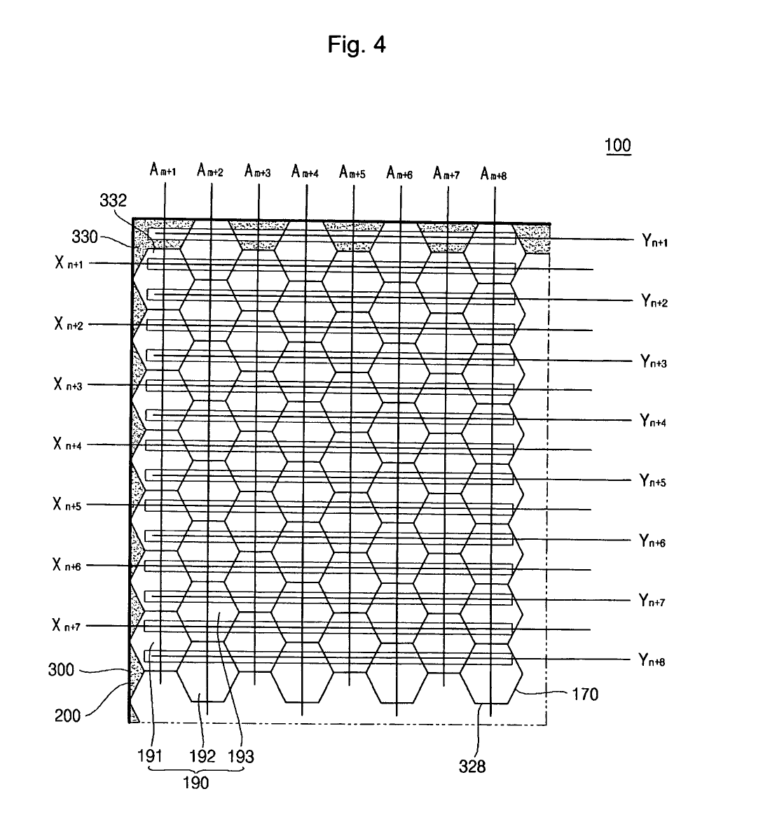

FIG. 4 is a front view of the PDP shown in FIG. 3.

Referring to FIG. 4, a PDP 100 constructed as one embodiment of the principles of the present invention includes display areas 332 (emissive areas) as a set of pixels and non-display areas 330 (non-emissive areas) aligned at outer portions of the display areas. In addition, external light absorber 200 is formed in non-display areas 330 in order to reduce the reflection brightness of PDP 100 in response to the incidence of the external light.

Herein, the term “display area” refers to an area to which the discharge voltage is applied through a plurality of discharge electrodes so that ultraviolet rays are generated in the process of plasma discharge and the visible rays are radiated when the fluorescent molecules in the fluorescent layer formed in the discharge cell are excited by the ultraviolet rays and then drop to the ground state in terms of energy, thereby realizing the image.

In addition, the term “non-display area” refers to an area located outside of the display areas and the sustain discharge is not generated between X and Y display electrodes 124 and 122. X electrodes 124, Y electrodes 122 and address electrodes 150 may extend into the non-display areas from the display areas, so that terminals of the above electrodes area are electrically connected to an external terminal of a signal transferring unit, such as a flexible printed cable.

According to the present invention, delta type barrier ribs 170 are employed so that the boundary lines between display areas 332 and non-display areas 330 are curved.

Although FIG. 4 shows the rotary delta type PDP 100 having hexagonal discharge cells 191, 192 and 193, in which each hexagonal discharge cell is formed in such a way that upper and lower end portions 328 of the hexagonal discharge cell are horizontal lines when viewed from the front of the hexagonal discharge cell, the present invention is also applicable for the general delta type PDP having hexagonal cells, in which each hexagonal cell is formed in such a way that left and right end portions of the hexagonal discharge cell are vertical lines when viewed from the front of the discharge cell. In addition, the present invention is also applicable for PDP 100 in which two address electrodes 150 are allocated to one pixel 190. Although rotary delta type PDP 100 may be constructed with two address electrode 150 allocated to one pixel 190, the rotary delta type PDP is not limited to this arrangement. In other words, the rotary delta type PDP may be constructed with two display electrodes, i.e. X and Y display electrodes 124 and 122, allocated to one pixel. In addition, the present invention is also applicable for the PDP having polygonal discharge cells, rather than the hexagonal discharge cells.

Referring again to FIG. 4, PDP 100 has a rectangular effective picture area 300 including entire display areas 332 and a part of non-display areas 330 adjacent to display areas 332. In other words, rectangular effective picture area 300 includes not only entire display areas 332, but also a part of non-display areas 330.

In addition, external light absorber 200 is provided in non-display areas 330 formed in rectangular effective picture area 300. In delta type PDP 100 having rectangular effective picture area 300, if rectangular effective picture area 300 is established with entire display areas 332, empty spaces may be inevitably formed due to the shape of delta type barrier ribs. The empty spaces correspond to non-display areas 330.

Such empty spaces 330 are typically coated with a dielectric layer or a fluorescent layer. The dielectric layer and the fluorescent layer are white in color, so they exhibit superior reflection brightness in response to the incidence of the external light onto non-display areas 330 (i.e. empty spaces). If non-display areas 330 have superior reflection brightness, the bright room contrast of PDP 100 may be degraded, thereby lowering the image quality of PDP 100.

For this reason, external light absorber 200 is provided in empty spaces 330 in order to improve the bright room contrast by reducing the reflection brightness in response to the incidence of external light onto empty spaces 330.

External light absorber 200 can be formed on rear surface 112 or front surface 114 of front substrate 110 corresponding to non-display areas 330. In this case, the reflection brightness of the PDP with respect to the external light can be effectively reduced if external light absorber 200 covers the entire non-display areas 330, which are formed in effective picture area 300, of rear surface 112 or front surface 114 of the front substrate 110. At this time, as shown in FIG. 4, the width of external light absorber 200 is periodically changed at the uppermost and lowermost sides and/or the rightmost and leftmost sides of discharge cells 191, 192 and 193.

In addition, external light absorber 200 can be formed with a recess having a depth. In this case, recess 118 having depth A as shown in FIG. 3 is formed in front surface 114 of front substrate 110 corresponding to non-display areas 330 and is filled with light shielding materials. The external light maybe incident slantwise into the discharge cells in non-display areas 330 from display areas 332. If external light absorber 200 has recess 118 with depth A, however, the external light is shielded by the light shielding materials filled in recess 118 before the external light is incident into the discharge cells in non-display areas 330.

In addition, external light absorber 200 can be formed on barrier ribs 170 forming discharge cells 191, 192 and 193, fluorescent layer 165, or dielectric layer 130 or 160, in the areas corresponding to non-display areas 330. In this case, the reflection brightness of the PDP with respect to the external light can be effectively reduced if external light absorber 200 covers entire light projection areas of barrier ribs 170, fluorescent layer 165 or dielectric layer 130 or 160 in such a manner that the entire surface of non-display areas 330 formed in effective picture area 300 can be covered with external light absorber 200.

In order to reduce the bright room contrast by using external light absorber 200, it is preferred if a discharge cell in non-display areas 330 formed with external light absorber 200 has a reflection brightness lower than an average reflection brightness of the discharge cells realizing the image.

Therefore, external light absorber 200 is preferably made from a material having a superior light absorption property. More preferably, external light absorber 200 is made from a material having a surface color of black.

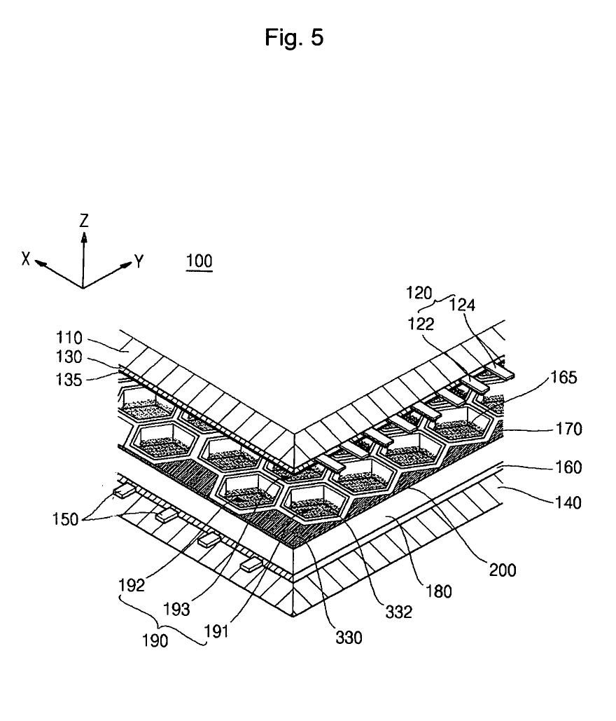

FIG. 5 is a partially enlarged perspective view illustrating a PDP 100 constructed as another embodiment of the principles of the present invention. Since PDP 100 shown in FIG. 5 is substantially identical to PDP 100 shown in FIGS. 3 and 4, the following description will focus on the difference between PDP 100 shown in FIG. 5 and PDP 100 shown in FIGS. 3 and 4.

Referring to FIG. 5, PDP 100 constructed as another embodiment of the principles of the present invention includes display areas 332 (emissive areas) as a set of pixels 190 and non-display areas 330 (non-emissive areas) aligned at outer portions of display areas 332. In addition, external light absorber 200 is formed in non-display areas 330 located in effective picture area 300 in order to reduce the reflection brightness of the PDP with respect to the external light.

In this case, a dummy wall 180 is formed in non-display areas 330 located in effective picture area 300. Dummy wall 180 extends from a barrier rib 170 forming an outermost portion of display areas 332 in order to reduce the space of the discharge cells corresponding to non-display areas 330 and external light absorber 200 is provided on dummy wall 180.

Although dummy wall 180 can be formed separately from barrier ribs 170, it is preferred to integrally form dummy wall 180 with barrier ribs 170 in order to facilitate the fabrication process for PDP 100.

If dummy wall 180 is not provided in non-display areas 332 of effective picture area 300, the pre-discharge, such as the address discharge, may be generated in the discharge cell belonging to the non-display areas. If electric charges are abnormally charged in the discharge cell belonging to the non-display areas, an abnormal discharge may be undesirably generated. If dummy wall 180 is provided in non-display areas 330 located in effective picture area 300, however, the space causing the pre-discharge or the abnormal discharge can be removed before the discharge occurs.

In addition, since external light absorber 200 is formed on dummy wall 180, the external light incident onto non-display areas 330 is absorbed by external light absorber 200 so that the reflection brightness of the PDP with respect to the external light can be reduced, thereby improving the bright room contrast.

At this time, the reflection brightness of the PDP with respect to the external light can be effectively reduced if external light absorber 200 covers the entire light projection areas of dummy wall 180 formed in non-display areas 330 in such a manner that the entire surface of non-display areas 330 formed in effective picture area 300 can be covered by external light absorber 200.

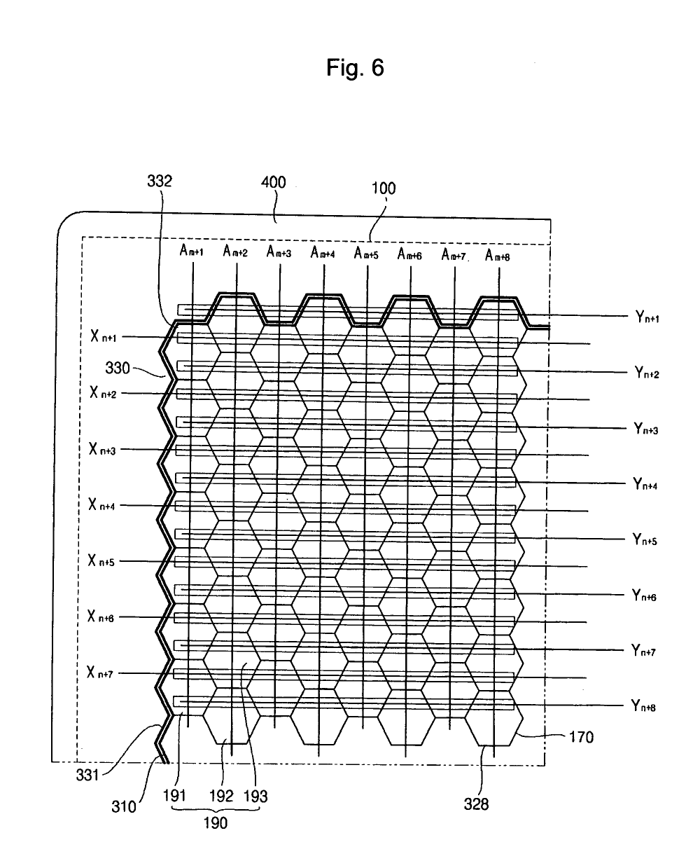

FIG. 6 is a front view of PDP 100 constructed as still another embodiment of the principles of the present invention. Since PDP 100 shown in FIG. 6 is substantially identical to PDP 100 shown in FIGS. 3 and 4, the following description will focus on the difference between the PDP shown in FIG. 6 and the PDP shown in FIGS. 3 and 4.

Referring to FIG. 6, PDP 100 constructed as still another embodiment of the principles of the present invention includes display areas 332 (emissive areas) as a set of pixels and non-display areas 330 (non-emissive areas) aligned at outer portions of display areas 332. In addition, PDP 100 has an effective picture area 310 including entire display areas, exclusively. In other words, the display areas 332 match with effective picture area 310.

Referring back to FIG. 2, the contemporary PDP employs rectangular effective picture area 300, in which a part of pixels that was originally belonging to the display areas deviates from effective picture area 300, so a color unbalance may occur at the edge portions of effective picture area 300. Thus, the contemporary PDP may not produce the desired color, which is intended to be seen by the viewer. To solve the above problem, according to the principles of the present invention, effective picture area 310 is aligned corresponding to a curved boundary line 331 formed between display areas 332 and non-display areas 330. In this case, the color balance can be obtained even in the edge portions of effective picture area 310 and non-display areas 330 are not formed in effective picture area 310 (i.e. display area 332 matches with effective picture area 310), thereby preventing the external light from being reflected from the non-display areas.

In order to establish the effective picture area 310 including entire display areas exclusively, front case 400 surrounding the PDP may cover the entire non-display areas 330.

Accordingly, it is possible to improve the bright room contrast by balancing the colors representing the image.

As described above, the PDP constructed as an embodiment of the principles of the present invention employs effective picture area 310 including entire display areas 332 exclusively, so that the color balance can be obtained even in the edge portions of effective picture area 310. In addition, if non-display areas 330 is provided in effective picture area 310, external light absorber 200 is provided in non-display areas 330 so that the reflection brightness of the external light incident into non-display areas 330 can be reduced, thereby improving the bright room contrast of the PDP.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A plasma display panel comprising:
front and rear substrates aligned opposite to each other;
barrier ribs provided between the front and rear substrates in order to define a plurality of discharge cells with each pixel being formed by three adjacent discharge cells radiating visible rays of different colors and being aligned in a triangular pattern;
a plurality of electrodes aligned on at least one of the front substrate, the rear substrate, and the barrier ribs corresponding to the discharge cells; and
a fluorescent layer formed in the discharge cells, wherein the plasma display panel comprises display areas, that are emissive areas, and non-display areas that are non-emissive areas aligned outside of the display areas, and an external light absorber provided in the non-display areas.

2. The plasma display panel as claimed in claim 1, comprised of boundary lines formed between the display areas and the non-display areas being curved.

3. The plasma display panel as claimed in claim 1, comprised of each discharge cell forming the pixel having a hexagonal shape, with left and right end portions of the hexagonal being vertical lines when viewed from a front of the hexagonal discharge cell.

4. The plasma display panel as claimed in claim 1, comprised of each discharge cell forming the pixel having a hexagonal shape, with upper and lower end portions of the hexagonal being horizontal lines when viewed from a front of the hexagonal discharge cell.

5. The plasma display panel as claimed in claim 1, comprising two address electrodes corresponding to one pixel.

6. The plasma display panel as claimed in claim 1, comprising a rectangular effective picture area including the entire display areas and a part of the non-display areas adjacent to the display areas.

7. The plasma display panel as claimed in claim 6, comprised of the external light absorber being provided in the non-display areas located in the effective picture area.

8. The plasma display panel as claimed in claim 7, comprised of the external light absorber being provided in a front surface or a rear surface of the front substrate corresponding to the non-display areas.

9. The plasma display panel as claimed in claim 8, comprised of a width of the external light absorber being periodically changed.

10. The plasma display panel as claimed in claim 7, comprised of the external light absorber including a recess having a depth, in which the recess is formed in a front surface of the front substrate corresponding to the non-display areas and is filled with light shielding materials.

11. The plasma display panel as claimed in claim 7, comprised of the external light absorber being disposed on the barrier ribs forming the discharge cells, the fluorescent layer or a dielectric layer corresponding to the non-display areas.

12. The plasma display panel as claimed in claim 7,comprised of a dummy wall being formed in the non-display areas located in the effective picture area, in which the dummy wall extends from a barrier rib forming an outermost portion of the display areas and the external light absorber is provided on the dummy wall.

13. The plasma display panel of claim 1, comprised of the external light absorber being made from a material having a surface color of black.

14. A plasma display panel comprising:
front and rear substrates aligned in opposition to each other;
barrier ribs provided between the front and rear substrates in order to define a plurality of discharge areas with each pixel is formed by three neighbor discharge cells radiating visible rays of different colors and being aligned in a triangular pattern;
a plurality of kinds of electrodes aligned on at least one of the front substrate, the rear substrate, and the barrier ribs corresponding to the discharge cells; and
a fluorescent layer formed in the discharge cells, wherein the plasma display panel comprises display areas, that are emissive areas, and non-display areas that are non-emissive areas aligned outside of the display areas, and an effective picture area is established by covering the entire display areas, exclusively.

15. The plasma display panel as claimed in claim 14, with a front case surrounding the plasma display panel being provided such that the entire non-display areas are covered with the front case.
